(19) United States
(12) Patent Application Publication
(10) Pub. No.: US 2009/0055810 A1
(43) Pub. Date: Feb. 26, 2009

(54) Method And System For Compilation And Execution Of Software Codes

(75) Inventor: Shankar Kondur, Highland Park, NJ (US)

Correspondence Address: Ashok Tankha, 36 Greenleigh Drive, Sewell, NJ, 08080, US

(73) Assignee: NCE Technologies Inc.

(21) Appl. No.: 12/039,756

(22) Filed: Feb. 29, 2008

(30) Foreign Application Priority Data
Aug. 21, 2007 (IN) 1866/CHE/2007

(51) Int. Cl. G06F 9/45

(52) U.S. Cl. 717/140

(57) ABSTRACT

The method and system disclosed herein is for compiling and executing a plurality of software codes. The requests from users are parsed and loaded using a set of child processes or a thread pool. A request handler is used to handle the compilation and execution requests from the user. Requests from a plurality of client processes are listed to compile and execute the solution codes from a plurality of users. A set of common libraries and system libraries for each compilation request are stored in a memory and loaded on to a compiler. Using the stored common libraries and system libraries, an executable binary format of the software code is created by the compiler. The executable binary format of the software code is loaded on a file system for further executions.

### BACKGROUND

The present invention relates to a method and system for compiling and executing a software code. More particularly, the present invention relates to a method and a system for concurrent compilation and execution of a plurality of software codes.

In the existing methods of compiling a software code, a compiler parses the software code, links the parsed software code with common libraries and system libraries, and creates an executable binary output of the software code. The software codes from multiple users are compiled separately with the above mentioned steps of parsing, linking, and creating binary outputs. The overheads for compilation and execution of these software codes increase with an increase in the number of software codes.

Loading and parsing of common libraries, system libraries, and header files for every compilation process increases the compilation time. Further, handling multiple requests for compilation may not be efficient. Therefore a standard compiler may not achieve a large number of compilations concurrently with limited resources. The above mentioned limitations increase with an increase in the number of compilation requests.

In view of the foregoing discussion there is an unmet need for a system and a method of achieving a large number of compilations concurrently with limited resources, handling multiple compilation and execution requests efficiently, and faster execution of a plurality of software codes.

### SUMMARY OF THE INVENTION

The method and system disclosed herein addresses the unmet need for a system and a method of achieving a large number of compilations concurrently with limited resources, handling multiple requests efficiently, and faster execution of a plurality of software codes.

A separate thread is provided on a virtual machine (VM) server to listen to broadcasts from a plurality of client processes requesting for the VM server's availability for compiling and executing a plurality of software codes. The VM server then broadcasts VM server information to the requesting client processes. Once the client process obtains the VM server information, a client socket sends a connection request to the VM server. A VM server socket listens to the incoming connection request from the client process. A request dispatcher is used to transmit requests to the VM server. Once the connection is established between the VM server and the client process, the incoming requests from the client process to the VM server is stacked in a request queue to be handled. The requests from the client processes are for compiling and executing the software codes submitted by the users. A request handler present in the VM server is used to handle the requests stacked in the request queue. The requests are taken from the request queue and handled by a request handler thread pool. The handled requests are stacked as run requests in a separate run request queue. A response queue is provided on the VM server to collect the responses to be transmitted to the client processes. The responses to the requests from the client processes may be the executable binary format of the software codes or the output generated by executing the software codes. The response handler provided on each of the client process handles the response from the VM server.

The method and system disclosed herein uses a compiler. The compiler uses a system file cache and a binary cache that are maintained for each client process. The common libraries, the system libraries and the header files required for each compilation are stored in the system file cache. The object files or class files obtained after each compilation are stored in the binary cache. During the compilation of the software code, if a required header or library is not available on the system file cache, the respective header or library file is loaded from a file system to the system file cache. The header or library file stored in the system cache is used for current and subsequent compilations. If the software code's source file is not modified since the last compilation, then the object file or the class file stored in the binary cache is used for compilation. The binary cache is updated with object files and class files generated with every new compilation. The libraries and headers stored in the system file cache and the object files and class files stored in the binary cache are linked to generate the required executable of the software code.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. The constructions below illustrate the invention in a single tenant scenario. The invention may also be used in a multi-tenant scenario, wherein a tenant key is added to all the relevant tables. However, the invention is not limited to the specific methods and instrumentalities disclosed herein.

FIG. 1 is an exemplary illustration of multiple compilation requests handling and compiling of multiple software codes.

FIG. 2 illustrates a first method of compiling and executing a plurality of software codes.

FIG. 3 illustrates a second method of compiling and executing a plurality of software codes.

### DETAILED DESCRIPTION OF THE DRAWINGS

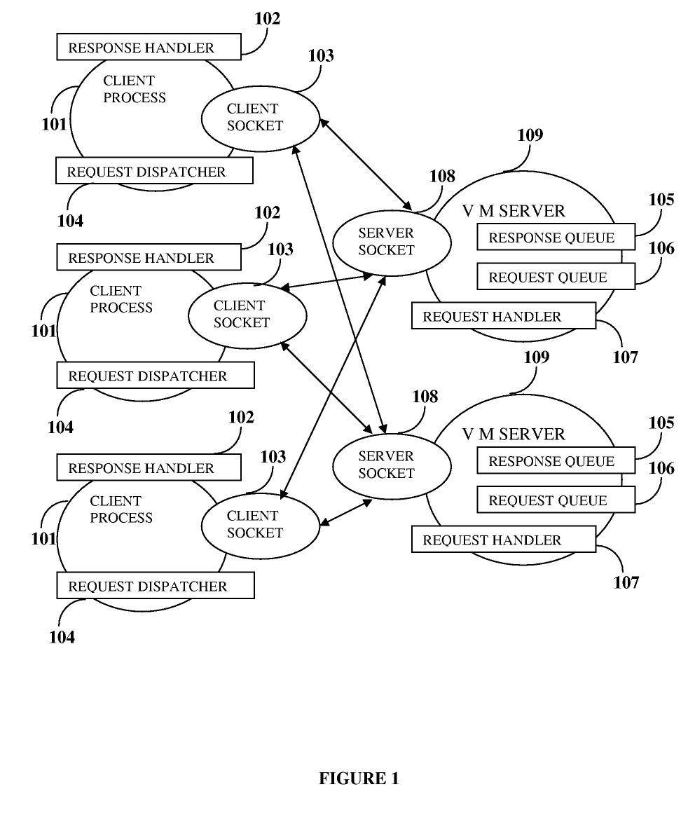

FIG. 1 is an exemplary illustration of multiple compilation requests handling and compiling of multiple software codes. Using client processes 101, software codes created by a plurality of users are transferred to a virtual machine (VM) server 109 for further compilation, execution, and evaluation of the software codes. Each user's requests for compilation and execution of the software codes are generated by the corresponding client process 101 and transmitted to the VM server 109. The VM server 109 comprises a request queue 106, a request handler 107, a response queue 105, and a VM server socket 108. Firstly, the VM server information is provided to each of the client processes 101. The information is transferred between the VM server socket 108 and the client sockets 103. The VM server information comprises the type of VM server 109, details of the listening port of the VM server 109, and the hostname of the VM server 109. A separate thread is provided on the VM server 109 to listen to broadcasts from the client processes 101 requesting for the VM server's 109 availability. The VM server 109 then broadcasts VM server information to the client processes 101. Once a client process 101 obtains the VM server information, the client socket 103 sends a connection request to the VM server 109. The VM server socket 108 listens to the incoming connection request from the client process 101. A request dispatcher 104 is used to transmit requests from the client process 101 to the VM server 109. The VM server socket 108 has the capability of accepting connections from multiple client processes 101. Once the connection is established between the VM server 109 and the client process 101, the incoming requests from the client process 101 to the VM server 109 is stacked in a request queue 106. The requests from the client processes 101 are for compiling and executing the software codes submitted by the users. Multiple requests to a VM server 109 may be issued from a single client process 101 or a plurality of client processes 101. The request handler 107 present in the VM server 109 is used to handle the requests stacked in the request queue 106. The requests are taken from the request queue 106 and handled by a request handler thread pool or a request handling set of forked child processes. The handled requests are stacked as run requests in a separate run request queue. Since the run task of the run requests can be time intensive, the run requests are handled by a separate run request handler thread pool or a run request handling set of forked child processes. The request handler thread pool and the run request handler thread pool are provided separately to avoid exhaustion of threads while handling multiple compilation requests. A response queue 105 is provided on the VM server 109 to collect the responses to be transmitted to the client processes 101. The responses to the requests from the client processes 101 may be the executable binary format of the software codes or the output obtained by executing the software codes. A binary cache is used to store object and class files, wherein the object and class files are generated by compiling the software codes. The response handler 102 provided on each of the client process 101 handles the response from the VM server 109. In one embodiment of the invention, a single VM server 109 is employed for compiling and in another embodiment of the invention, a plurality of VM servers 109 may be employed for compilation and execution of software codes.

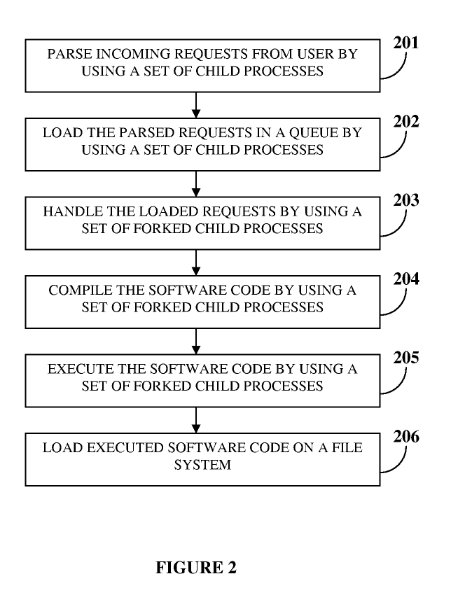

FIG. 2 illustrates a first method of compiling and executing a plurality of software codes. The client processes 101 broadcast requests for availability of the VM server 109 for compiling the software codes. Through a listening port, the VM server 109 continually listens to the broadcasts for requests from the client processes 101. Further the VM server 109 sends the VM server information to a client process 101 announcing the VM server's 109 availability for handling compilation requests. The availability of the VM server 109 is handled by a separate thread.

A request handling set of child processes is used for parsing 201 incoming requests and loading 202 the incoming requests in a request queue 106. A compilation set of child processes is used for compiling the software codes and an execution set of child processes is used for executing the compiled software codes. Each of the three sets of child processes is forked. The request handling set of forked child processes listens to the compilation and execution requests from each of the plurality of client processes 101. The request handling set of forked child processes then accepts and stacks the compilation and execution requests in a request queue. The request handling set of forked child processes further separates the requests for compilation and requests for execution of the software codes. The request handling set of forked child processes transfers the execution requests from the request queue to a run request queue and stacks the execution requests in the run request queue. The compilation set of forked child processes handles 203 the requests from the request queue and compiles 204 the software codes corresponding to the handled requests. The compilation set of forked child processes then sends a compilation response back to the client process 101. The execution set of forked child processes handles 203 the run requests from the run request queue and executes 205 the software codes corresponding to the handled run requests. The executed software code is then loaded on a file system 206. The execution set of forked child processes then sends the execution response back to the client process 101.

In one implementation of the first method of compiling and executing a plurality of software codes, the software codes may be coded in a C/C++ programming language. In another implementation of the first method, the software codes may be coded in Java® programming language.

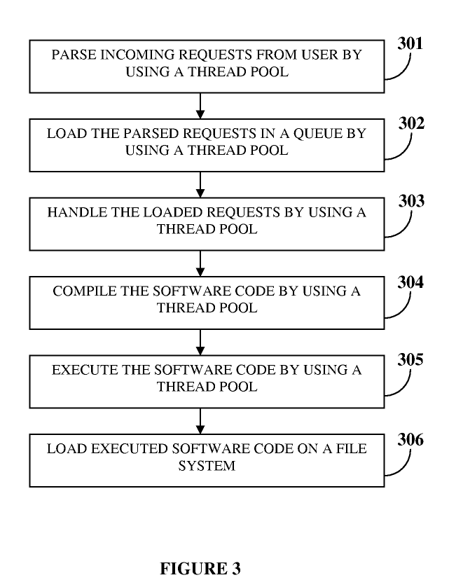

FIG. 3 illustrates a second method of compiling and executing a software code. The client processes 101 broadcast requests for availability of the VM server 109 for compiling the software codes. Through a listening port, the VM server 109 continually listens to the broadcasts for requests from the client processes 101. Further the VM server 109 sends the VM server information to a client process 101 announcing the VM server's 109 availability for handling compilation requests. The availability of the VM server 109 is handled by a separate thread.

A request handling thread pool is provided to handle the incoming compilation and execution requests from the client processes 101. The request handling thread pool continually listens to compilation and execution requests from client processes 101. The request handling thread pool then accepts and stacks the compilation and execution requests in a request queue. The request handling thread pool further separates the compilation and execution requests. The request handling thread pool transfers the execution requests from the request queue to a run request queue and stacks the requests in the run request queue. A compilation thread pool handles 303 the requests from the request queue and compiles 304 the software codes corresponding to the handled requests. The compilation thread pool requests then sends a compilation response back to the client process 101. An execution thread pool handles 303 the execution requests from the run request queue and executes 305 the software codes corresponding to the handled run requests. The executed software code is then loaded on a file system 306. The execution thread pool then sends the execution response back to the client process 101.

In one implementation of the invention, the compiler employs a system file cache and a binary cache. The system file cache is used to store the common libraries and system libraries required for the compilation of the software codes. Header files required for compiling software codes coded in C/C++ programming language may also be stored in the system file cache. The binary cache is used to store the object files and class files generated as outputs from the compilation of software codes. The object files are generated when software codes coded in C/C++ programming language are compiled. The class files are generated when software codes coded in Java programming language are compiled. The binary cache is maintained separately for each client process 101. During the compilation of a software code, if a required header or library file is not available on the system file cache, the required header or library file is loaded from a file system to the system file cache. The loaded header or library file is used for current and subsequent compilation of the software codes. The system file cache is updated when a new compilation request, requiring a header or a library file not present in the system file cache, is processed.

During the compilation of a software code coded in C/C++ programming language, if a source file of the software code has not undergone modifications since the previous compilation, then the object file stored in the binary cache from the previous compilation of the source file is used for current compilation of the C/C++ software code. During the compilation of a software code coded in Java programming language, if a source file of the software code has not undergone modifications since the previous compilation, then the class file stored in the binary cache from the previous compilation of the source file is used for current compilation of the Java software code.

The system file cache and the binary file cache are updated with every compilation. For the execution of a C/C++ software code, the required common libraries, system libraries, and the header files stored in the system file cache are linked with the object files in the binary cache to generate an executable file from the software code. For the execution of a Java software code, the required class libraries, system libraries, and other common libraries stored in the system file cache are linked with the class files in the binary cache to generate an executable file from the software code. The final executable files may then be written into a file system.

In the disclosed invention for compiling C/C++ software codes, an open source compiler such as Intel® C++ compiler, Ten DRA® compiler, GNU compiler collection (GCC), open Watcom® C compiler, etc., may be used for compilation. For compiling Java software codes, an open source compiler such as Jikes compiler from IBM, Inc., the Sun's JDK from Sun Microsystems, Inc., Eclipse® compiler, etc., may be used for compilation. The compilation features described above may be incorporated in such open source compilers.

It will be readily apparent to those skilled in the art that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or Java®. The software programs may be stored on or in one or more mediums as an object code. A computer program product, comprising computer executable instructions embodied in a computer-readable medium, comprises computer parsable codes for the implementation of the processes of various embodiments.

Where databases are described, such as the question compendia database 109e, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on Intel® processors that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method of compiling and executing a plurality of software codes provided by a plurality of clients, comprising the steps of:
providing a request handling set of child processes to handle compilation and execution requests from said plurality of clients, wherein said request handling set of child processes are forked;
providing a compilation set of child processes, wherein said compilation set of child processes are forked;
providing an execution set of child processes, wherein said execution set of child processes are forked;
parsing said compilation and execution requests using the request handling set of child processes;
loading said parsed compilation and execution requests in a request queue using the request handling set of child processes;
transferring the execution requests from said request queue to a run request queue using the request handling set of child processes;
compiling said plurality of software codes by processing the compilation requests in the request queue using the compilation set of child processes; and
executing the plurality of software codes by processing the execution requests in the run request queue using the execution set of child processes.

2. The method of claim 1, wherein the request handling set of child processes listen for broadcasts of requests from each of the plurality of clients.

3. The method of claim 1 further comprising the step of transmitting a response to a requesting client subsequent to the handling of a request of said requesting client, wherein said request is one of a compilation and an execution request.

4. A method of compiling and executing a plurality of software codes provided by a plurality of clients, comprising the steps of:
providing a request handling thread pool to handle compilation and execution requests from said plurality of clients;
providing a compilation thread pool;
providing an execution thread pool;
parsing said compilation and execution requests using said request handling thread pool;
loading said parsed compilation and execution requests in a request queue using the request handling thread pool;
transferring the execution requests from said request queue to a run request queue using the request handling thread pool;
compiling said plurality of software codes based on the compilation requests in the request queue using said compilation thread pool; and
executing the plurality of software codes based on the execution requests in the run request queue using said execution thread pool.

5. The method of claim 4, wherein said step of compiling the plurality of software codes comprises linking each of the plurality of software codes with common libraries and system libraries.

6. The method of claim 4, wherein said step of compiling the plurality of software codes comprises loading said common libraries and system libraries, storing the common libraries and system libraries in a system file cache, loading and parsing each of plurality of software codes, and linking said parsed software codes with the common libraries and system libraries.

7. The method of claim 6, wherein said system file cache stores header files used for compiling C and C++ software codes.

8. The method of claim 5, wherein said system file cache stores class libraries for compiling Java® software codes.

9. The method of claim 4, wherein said step of compiling the plurality of software codes comprises storing object files in a binary cache, wherein said stored object files are used in subsequent compilations of the C and C++ software codes.

10. The method of claim 4, wherein said step of compiling the plurality of software codes comprises storing class files in the binary cache, wherein said stored class files are used in subsequent compilations of the Java® software codes.

11. A system for compiling and executing a plurality of software codes provided by a plurality of clients, comprising:
a compilation server to compile each of said plurality of software codes, said compilation server comprising:
a parsing module to parse incoming compilation and execution requests from said plurality of clients;
a request handler to load said compilation and execution requests in a queue;
a system file cache to store common libraries and system libraries;
a compiler to link each of the plurality of software codes with said stored common libraries and system libraries, and compile said linked software codes;
a binary cache to store output files generated by compiling the linked software codes;
an execution module to execute said compiled software codes; and
a file system to load said executed software codes.

12. The system of claim 11, wherein said system file cache is used for storing header files used for compiling C and C++ software codes.

13. The system of claim 11, wherein said system file cache is used for storing class libraries used for compiling Java software codes.

14. The system of claim 11, wherein said binary cache stores object files generated by compiling C and C++ software codes.

15. The system of claim 11, wherein said binary cache stores class files generated by compiling Java software codes.

16. A computer program product comprising computer executable instructions embodied in a computer-readable medium, said computer program product including:
a first computer parsable program code for providing a request handling set of child processes to parse incoming compilation and execution requests and load said parsed requests in a queue, wherein said request handling set of child processes are forked;
a second computer parsable program code for providing a request handling thread pool to parse incoming compilation and execution requests and load said parsed requests in a queue;
a third computer parsable program code for providing a compilation set of child processes to compile a plurality of software codes, wherein said compilation set of child processes are forked;
a fourth computer parsable program code for providing a compilation thread pool to compile said plurality of software codes;
a fifth computer parsable program code for parsing and loading common libraries and system libraries;
an sixth computer parsable program code for storing said parsed common libraries and system libraries in a system file cache;
a seventh computer parsable program code for parsing and loading the plurality of software codes, and linking said parsed software codes with the parsed common libraries and system libraries;
an eighth computer parsable program code for providing an execution set of child processes to execute the plurality software codes, wherein said execution set of child processes are forked;
a ninth computer parsable program code for providing an execution thread pool to execute the plurality of software codes; and
a tenth computer parsable program code for loading said executed software codes on a file system.
